(19) United States
(12) Patent Application Publication
(10) Pub. No.: US 2017/0142120 A1
(43) Pub. Date: May 18, 2017

(54) METHOD FOR DETECTING OPERATIONS OF FUNCTION MANAGEMENT AND CONFIGURATION SERVER, LEGITIMATE CLIENT, CONTENT DELIVERY NETWORK (CDN) NODE, AND SYSTEM

(71) Applicants: LE HOLDINGS (BEIJING) CO., LTD., Beijing (CN); LECLOUD COMPUTING CO., LTD., Beijing (CN)

(72) Inventor: Hongfu Li, Beijing (CN)

(21) Appl. No.: 15/248,755

(22) Filed: Aug. 26, 2016

Related U.S. Application Data
(63) Continuation of application No. PCT/CN2016/083202, filed on May 24, 2016.

(30) Foreign Application Priority Data
Nov. 16, 2015 (CN) 201510783892.1

(51) Int. Cl. H04L 29/06

(52) U.S. Cl. CPC H04L 63/102; H04L 63/101

(57) ABSTRACT

Disclosed is a method for detecting operations of a function management and configuration server, a legitimate client, a content delivery network (CDN) node, and a system. The method includes: at an electronic device, sending a function access request to a CDN node; when the CDN node determines that feedback information of the function access request should be an access refusal result, receiving feedback information of allowed access returned by the CDN node; and based on the feedback information, parsing the access refusal result of the characteristic information, and reporting error information such that the CDN node determines that an error occurs in the operations of the function management and configuration server. The present disclosure can accurately detect if an error occurs in the operations of a function management and configuration server and a location of the error, so that a legitimate client can access various functions smoothly.

### CROSS REFERENCE TO RELATED APPLICATIONS

This application is a continuation of International Application No. PCT/CN2016/083202, filed on May 24, 2016, which is based upon and claims priority to Chinese Patent Application No. 201510783892.1, filed on Nov. 16, 2015, the entire contents of each of which are incorporated herein by reference.

### TECHNICAL FIELD

The disclosure relates to the technical field of computer testing and, more particularly, to a method for detecting operations of a function management and configuration server, a legitimate client, a content delivery network (CDN) node, and a system.

### BACKGROUND

With rapid development of Internet technologies, people often need to acquire desired resources by accessing networks. Network suppliers continuously add new functions and services, and optimize services to meet people's demands. Each time a network supplier launches a new function, operation states of the function need to first be tested internally by the network supplier to detect defects (such as pirate links and program problems), and if any problems are located, the system is then upgraded. As there are many functions of various types to be tested, a great deal of human power and materials are wasted. In addition, the accuracy of testing may not be desirable (for example, detection of the same piece of information by the same server in different regions may be different). Once the wrong determinations are made (for example, anti-pirate link processing is performed for a legitimate user such that normal access requests sent by the legitimate user are refused), user experience will be negatively affected, and a legitimate user may lodge complaints.

Therefore, how to accurately detect operations of a function management and configuration server and avoid wrong determinations, so as to safeguard the rights and interests of legitimate users, has become a concern for the industry.

### SUMMARY

Embodiments of the present disclosure include methods for detecting operations of a function management and configuration server, a legitimate client, a content delivery network (CDN) node, and a system, and aims to solve the aforementioned technical problems in that operations of a function management and configuration server cannot be detected accurately, and wrong determinations may occur, which lead to legitimate users being unable to access network resources normally.

According to an embodiment of the present disclosure, a method for detecting operations of a function management and configuration server, which configures functions for a CDN node. The method may include: sending a function access request to the CDN node; receiving feedback information of allowed access returned from the CDN node by a legitimate client when the CDN node determines that feedback information of the function access request should be an access refusal result, wherein the feedback information includes characteristic information specific to the legitimate client and corresponding to the access refusal result; and parsing the access refusal result of the characteristic information by the legitimate client based on the feedback information, and reporting error information corresponding to the access refusal result by the legitimate client such that the CDN node determines that an error occurs in the operations of the function management and configuration server based on the error information reported by the CDN node.

According to another embodiment of the present disclosure, a method is provided for detecting operations of a function management and configuration server, which configures functions for a CDN node. The method may include: receiving, by the CDN node, a function access request sent by a legitimate client; when the CDN node determines that feedback information of the function access request should be an access refusal result, returning, by the CDN node, feedback information of allowed access to the legitimate client, wherein the feedback information includes characteristic information specific to the legitimate client and corresponding to the access refusal result; and receiving, by the CDN node, error information corresponding to the access refusal result and reported by the legitimate client, and determining, by the CDN node, that an error occurs in the operations of the function management and configuration server based on the reported error information.

According to yet another embodiment of the present disclosure, a legitimate client is provided for detecting operations of a function management and configuration server, which configures functions for a content delivery network (CDN) node. The legitimate client may include at least one processor and a memory in electronic communication with the processor having instructions stored thereon, wherein execution of the instructions by the at least one processor causes the at least one processor to send a function access request to the CDN node; receive feedback information of allowed access returned by the CDN node when the CDN node determines that feedback information of the function access request should be an access refusal result, wherein the feedback information includes characteristic information specific to the legitimate client and corresponding to the access refusal result; parse the access refusal result of the characteristic information based on the feedback information, and report error information corresponding to the access refusal result such that the CDN node determines that an error occurs in the operations of the function management and configuration server based on the reported error information.

According to yet another embodiment of the present disclosure, a content delivery network (CDN) node is provided for detecting operations of a function management and configuration server, which configures functions for the CDN node. The CDN node may include at least one processor and a memory in electronic communication with the processor having instructions stored thereon, wherein execution of the instructions by the at least one processor causes the at least one processor to: receive a function access request sent by a legitimate client; return feedback information of allowed access to the legitimate client when it is determined that feedback information of the function access request should be an access refusal result, wherein the feedback information includes characteristic information specific to the legitimate client and corresponding to the access refusal result; and receive error information corresponding to the access refusal result and reported by the legitimate client, and determine that an error occurs in the operations of the function management and configuration server based on the reported error information.

According to yet another aspect of embodiments of the present application, also a system is provided for detecting operations of a function management and configuration server. The system may include the above CDN node and/or the above legitimate client.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flow chart of an embodiment of a method for detecting operations of a function management and configuration server of the present application;

FIG. 2 is a schematic flow chart of another embodiment of a method for detecting operations of a function management and configuration server of the present application;

FIG. 3 is a schematic sub-flow chart of the flow chart in FIG. 2;

FIG. 4 is a schematic structural view of a legitimate client for detecting operations of a function management and configuration server of the present application;

FIG. 5 is a schematic structural view of a content delivery network (CDN) node for detecting operations of a function management and configuration server of the present application;

FIG. 6 is a schematic structural view of a system for detecting operations of a function management and configuration server of the present application; and

FIG. 7 is a schematic structural view of a computer system of a terminal device or server for realizing the embodiments of the present application.

### DETAILED DESCRIPTION

In order to make the purpose, technical solutions, and advantages of the embodiments of the invention more clearly, technical solutions of the embodiments of the disclosure will be described clearly and completely in conjunction with the figures. Obviously, the described embodiments are merely part of the embodiments of the disclosure, but do not include all possible embodiments. Based on the embodiments of the disclosure, other embodiments obtained by the ordinary skill in the art without undue experimentation are within the scope of the disclosure.

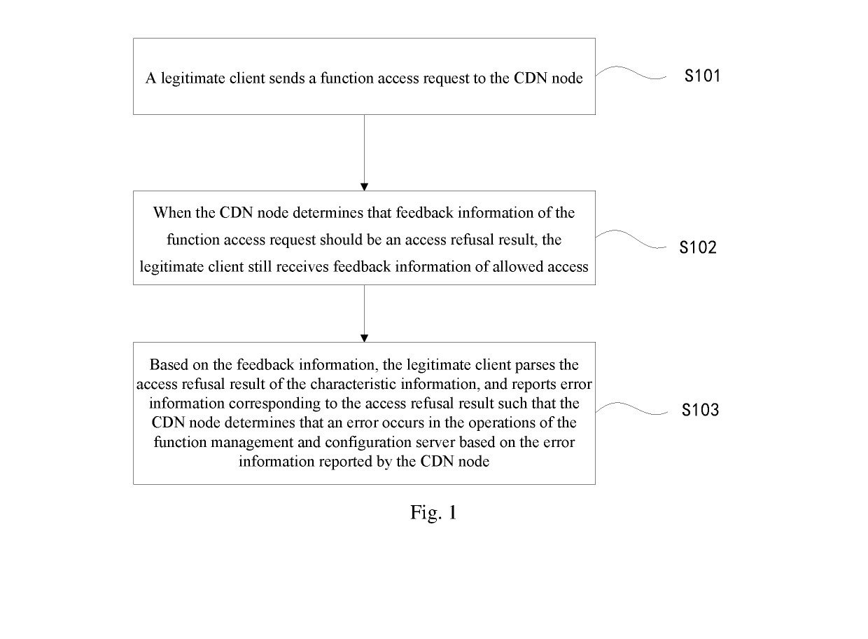

FIG. 1 is a schematic flow chart of an embodiment of a method for detecting operations of a function management and configuration server of the present application. In an embodiment, the method for detecting operations of a function management and configuration server of the present application may include the following steps, as shown in FIG. 1:

In step S101, a legitimate client sends a function access request to the CDN node.

In various embodiments of the present application, clients may include legitimate clients and illegitimate clients. A legitimate client is integrated with codes or software development kits (SDKs) compatible with CDN nodes, and can send a request of accessing network resources to a CDN node through an application interface. In various embodiments of the present application, there may be a plurality of legitimate clients who can send function access requests to a CDN node from different regions respectively. An illegitimate client, on the other hand, is not integrated with codes or SDKs compatible with CDN nodes, and does not have any authorization to send a function access request to any CDN node.

In step S102, when the CDN node determines that feedback information of the function access request should be an access refusal result, the legitimate client still receives feedback information of allowed access, wherein the feedback information includes characteristic information that is specific to the legitimate client and corresponds to the access refusal result.

Usually, if the CDN node determines that the client sending the function access request does not have any access authorization, the CDN node rejects the illegitimate access request of the client. However, in some cases, (for example, detection results for the same piece of information by the CDN node in different regions may be different), the CDN node may determine that a legitimate access request is an illegitimate access request. Thus, there is a possibility of the wrong determination by a unilateral determination of the CDN node. In such a case, if the CDN node rejects the access request, and the rights of legitimate clients may be impacted in a negative way.

In various embodiments, if the CDN node determines that the client sending the function access request does not have any access authorization, the CDN node does not directly reject the access request, but still allows sending feedback information of allowed access to the legitimate clients. The difference is that specific processing is performed on the feedback information in this case. For example, characteristic information specific to the legitimate client corresponding to the access refusal result may be embedded into the feedback information. Thus, wrong determinations can be avoided, and the rights of legitimate clients can be ensured.

In step S103, based on the feedback information, the legitimate client parses the access refusal result of the characteristic information, and reports error information corresponding to the access refusal result such that the CDN node determines that an error occurs in the operations of the function management and configuration server based on the error information reported by the CDN node.

In the present embodiment, a legitimate client is integrated with a special tool package for parsing special field information, while an illegitimate client is not integrated with such a special tool package. Thus, by adding special field information specific to the legitimate client (and which corresponds to the access refusal result) to the feedback information, the legitimate client can parse the access refusal result information in the special field information. Thus, the legitimate client can report the error information, and the CDN node can determine that an error occurs in the operations of the function management and configuration server based on the error information reported by the CDN node.

In the present embodiment, the legitimate client may (based on the feedback information), parse access refusal result of the characteristic information, and report client error information corresponding to the access refusal result, which may include, for example: periodically counting received feedback information to parse the access refusal result of the characteristic information; and reporting the error information corresponding to the access refusal result.

In the present embodiment, the legitimate client may periodically count the received feedback information, parse the access refusal result of the characteristic information, and report the error information corresponding to the access refusal result. In this way, the reporting center can collect error information in batches and can periodically determine if an error occurs in the operations of the function management and configuration server based on the reported error information, so that the error can be treated and removed periodically and human power can be saved substantially.

In the present embodiment, the legitimate client may parse the access refusal result of the characteristic information immediately (or nearly so) after receiving the feedback information, and report the error information corresponding to the access refusal result. In this way, the reporting center can collect error information immediately and immediately determine that an error occurs in the operations of the function management and configuration server based on the reported error information, so that the error can be treated and removed in a timely manner.

The manner of reporting the error information in this embodiment may be tailored according to the desired needs to improve user satisfaction.

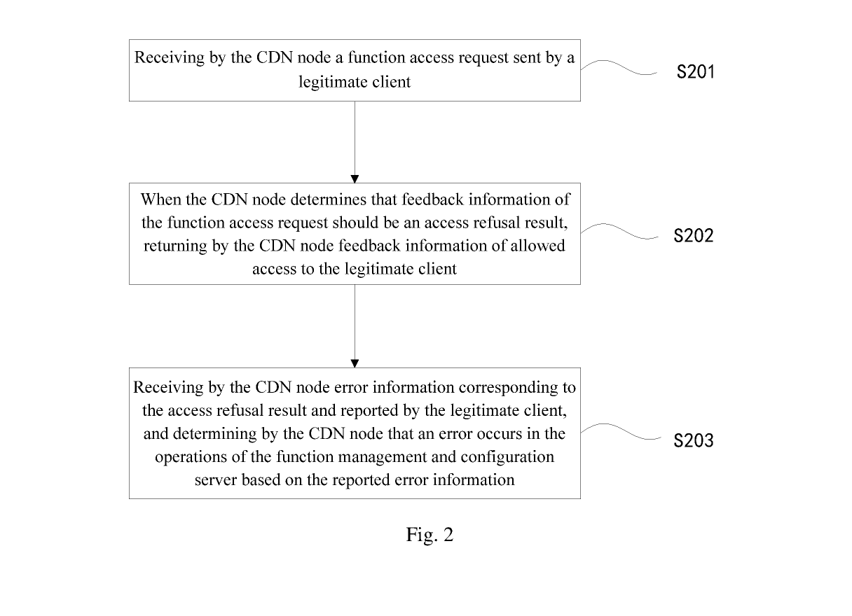

FIG. 2 is a schematic flow chart of another embodiment of a method for detecting operations of a function management and configuration server of the present application. In an embodiment, The method shown in FIG. 2 is similar to that shown in FIG. 1, and therefore similar steps may be referred to in the solution shown in FIG. 1, and are not repeated for purposes of brevity. In an embodiment, the method may include, for example the following steps as shown in FIG. 2:

step S201: receiving, by the CDN node, a function access request sent by a legitimate client;

step S202: when the CDN node determines that feedback information of the function access request should be an access refusal result, returning, by the CDN node, feedback information of allowed access to the legitimate client, wherein the feedback information includes characteristic information specific to the legitimate client and corresponding to the access refusal result; and

step S203: receiving, by the CDN node, error information corresponding to the access refusal result and reported by the legitimate client, and determining, by the CDN node, that an error occurs in the operations of the function management and configuration server based on the reported error information.

The embodiments of the present application may provide several advantages. First, by collecting error information reported by legitimate clients, an error that occurs in the operations of the function management and configuration server can be detected accurately, and a location of the error (for example, an upstream server error, a downstream client error or a network error) can likewise be detected accurately. Second, wrong determinations can be avoided, so that legitimate clients can access various functions smoothly. Third, after the period of testing operations of a function management and configuration server terminates, by restoring the conventional settings (for example, when the CDN node determines that feedback information of the function access request should be an access refusal result, feedback information will not be sent to the legitimate client), a testing state of the server can be switched to its normal operation state conveniently, thereby saving human power and hardware resources.

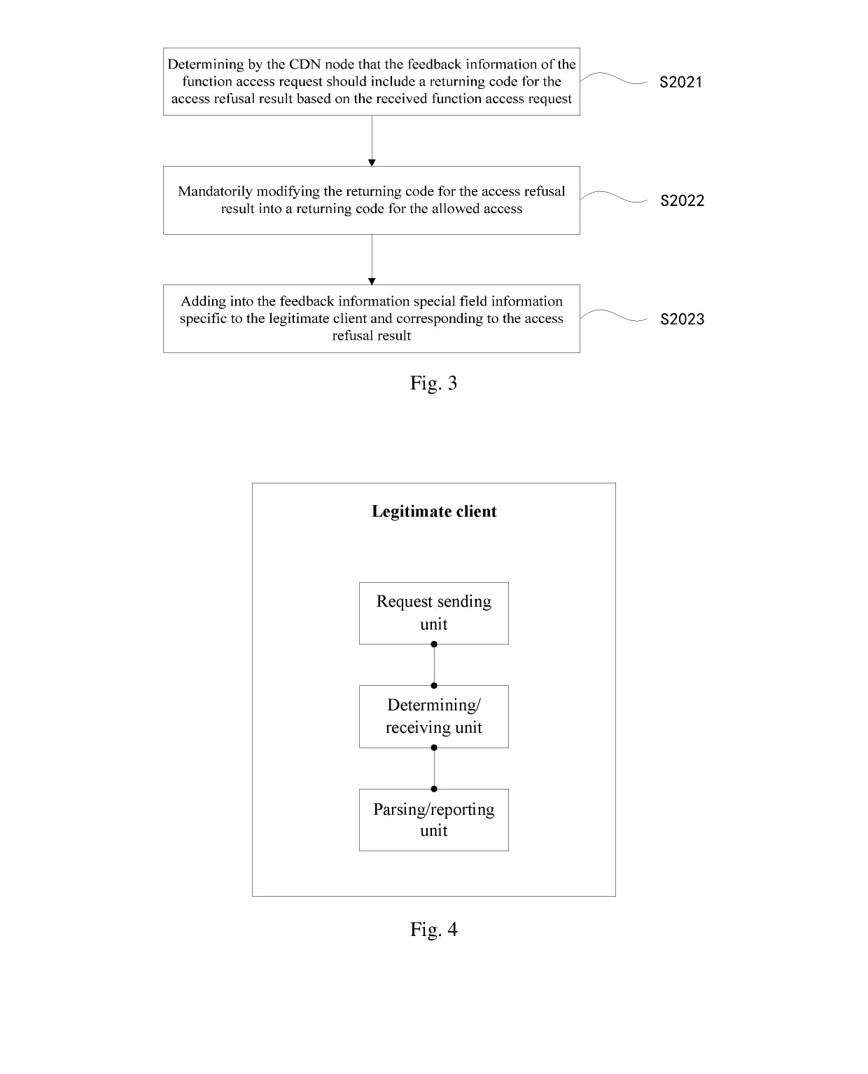

FIG. 3 is a schematic sub-flow chart of the flow chart in FIG. 2. In an embodiment, the step S202 (namely, when the CDN node determines that feedback information of the function access request should be an access refusal result, the legitimate client still receives feedback information of allowed access, wherein the feedback information includes characteristic information specific to the legitimate client and corresponding to the access refusal result), may include the following steps, as shown in FIG. 3:

step S2021: determining, by the CDN node, that the feedback information of the function access request should include a returning code for the access refusal result based on the received function access request;

step S2022: mandatorily modifying the returning code for the access refusal result into a returning code for the allowed access; and

step S2023: adding into the feedback information special field information that is specific to the legitimate client and corresponds to the access refusal result.

In the present embodiment, by compulsorily modifying the returning code and adding it to the feedback information as special field information specific to the legitimate client, information can be sent to the legitimate client quickly and conveniently. In this way, identification of the information by illegitimate clients can be prevented. Thus, security levels for information transmission are improved, and rights of legitimate clients to access various functions are protected.

In the present embodiment, when a protocol of the function access request is HTTP, a returning code for the access refusal is “403,” and a returning code for the allowed access is “200.”

The following illustrative example explains how the CDN node will detect operations of a function management and configuration server when an illegitimate client intends to pirate a link and sends an HTTP request to a CDN node.

In the present embodiment, the CDN node receives the HTTP request and acquires characteristic information therefrom. When the CDN node determines that the HTTP request may be a link pirating request for the first time, pirate link processing will not be performed to the HTTP request (for example, an error code 403 is set for HTTP request). Instead, information corresponding to the HTTP request is stored in certain byte fields, and a code 200 is set, and the returning code for refused access is 403. A webpage popping up on the requesting party may read “access is prohibited; the HTTP error code is 403; the server rejected your viewing request; please confirm your access authorization.” A state code 200 of the HTTP protocol means that the server has accepted the request (the returning code for allowed access may be 200). Usually, this means that the server provides the requested webpage.

In the present embodiment, when error information is reported by a legitimate client, an error code 403 will be sent directly for the HTTP request. As the client is provided by the service provider itself, when error information is reported by a client, it can be determined that the error information is reliable.

In the present embodiment, by collecting the error information reported by legitimate clients, errors in the operations of the function management and configuration server can be detected accurately, and legitimate rights for accessing various functions by legitimate clients can be guaranteed.

FIG. 4 is a schematic structural view of a legitimate client for detecting operations of a function management and configuration server of the present application. As shown in FIG. 4, the legitimate client may include, for example, at least one processor, and a memory in electronic communication with the processor having instructions stored thereon. The at least one processor and/or a memory of the legitimate client may be implemented to facilitate various functionalities, which are represented in FIG. 4, for example, as a request sending unit configured to send a function access request to the CDN node; a determining/receiving unit configured to, when the CDN node determines that feedback information of the function access request should be an access refusal result, receive feedback information of allowed access returned by the CDN node, wherein the feedback information includes characteristic information specific to the legitimate client and corresponding to the access refusal result; and a parsing/reporting unit configured to, based on the feedback information, parse access refusal result of the characteristic information, and report error information corresponding to the access refusal result such that the CDN node determines that an error occurs in the operations of the function management and configuration server based on the reported error information.

In the present embodiment, the parsing/reporting unit includes a timing/counting unit implemented by the at least one processor and/or memory of the legitimate client and configured to periodically count received feedback information, parse the access refusal result of the characteristic information, and report the error information corresponding to the access refusal result.

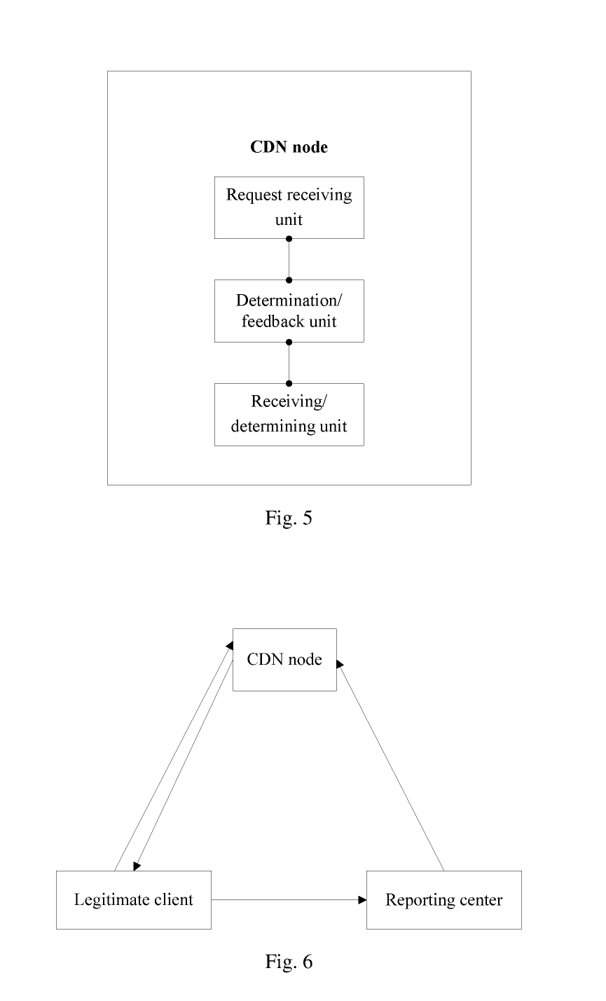

FIG. 5 is a schematic structural view of a content delivery network (CDN) node for detecting operations of a function management and configuration server of the present application. As shown in FIG. 5, the CDN node may include at least one processor and a memory in electronic communication with the processor having instructions stored thereon. The at least one processor and/or a memory of the CDN may be implemented to facilitate various functionalities, which are represented in FIG. 5, for example, as a request receiving unit configured to receive a function access request sent by a legitimate client; a determination/feedback unit configured to, when determining that feedback information of the function access request should be an access refusal result, return feedback information of allowed access to the legitimate client, wherein the feedback information includes characteristic information specific to the legitimate client and corresponding to the access refusal result; and a receiving/determining unit configured to receive error information corresponding to the access refusal result and reported by the legitimate client, and determine that an error occurs in the operations of the function management and configuration server based on the reported error information.

The embodiments described herein may provide several advantages. First, by collecting error information reported by legitimate clients, an error that occurs in the operations of the function management and configuration server can be detected accurately, and a location of the error (for example, an upstream server error, a downstream client error or a network error) can likewise be detected accurately. Second, wrong determinations can be avoided, so that legitimate clients can access various functions smoothly. Third, after the period of testing operations of a function management and configuration server ends, by restoring the conventional settings (for example, when the CDN node determines that feedback information of the function access request should be an access refusal result, feedback information will not be sent to the legitimate client), a testing state of the server can be switched to its normal operation state conveniently, saving human power and hardware resources.

In the present embodiment, the determination/feedback unit includes: a returning code determining unit configured to determine that the feedback information of the function access request should include a returning code for the access refusal result based on the received function access request; a returning code modifying unit configured to mandatorily modify the returning code for the access refusal result into a returning code for the allowed access; and an information adding unit configured to add into the feedback information special field information specific to the legitimate client and corresponding to the access refusal result.

FIG. 6 is a schematic structural view of a system for detecting operations of a function management and configuration server of the present application. The system may be implemented, for example, as including the above CDN node and/or the above legitimate client. The system may also be implemented, for example, as including a reporting center. In an embodiment, the legitimate client may include the above CDN node, the above legitimate client, and the reporting center, as shown in FIG. 6.

In the present embodiment, the legitimate client is integrated with a special tool package for parsing the special field information. That is, when a protocol of the function access request is HTTP, a returning code for the access refusal result is 403 and a returning code for the allowed access is 200.

Furthermore, in the present embodiment the legitimate client may include a parsing device and a reporting device, which may be configured to parse the access refusal result of the characteristic information immediately after receiving the feedback information. The parsing device may be configured to periodically count the received feedback information, and periodically parse the access refusal result of the characteristic information.

In the present embodiment, a legitimate client is integrated with a special tool package for parsing the special field information, while an illegitimate client is not integrated with a special tool package for parsing the special field information. By adding the special field information specific to the legitimate client (which corresponds to the access refusal result) to the feedback information, the legitimate client can parse information of the access refusal result in the special field information. This facilitates the legitimate client reporting the error information. In this way, the CDN node can determine that an error occurs in the operations of the function management and configuration server based on the reported error information.

Thus, by collecting the error information reported by legitimate clients, errors in the operations of the function management and configuration server can be detected accurately, and legitimate rights for accessing various functions by legitimate clients can be guaranteed.

In the present embodiment, the legitimate client may parse the access refusal result of the characteristic information immediately after receiving the feedback information, and report the error information corresponding to the access refusal result. In this way, the reporting center can collect error information immediately and immediately determine that an error occurs in the operations of the function management and configuration server based on the reported error information, so that the error can be treated and removed in a timely manner.

In the present embodiment, the legitimate client may periodically count the received feedback information, parse the access refusal result of the characteristic information, and report the error information corresponding to the access refusal result. In this way, the reporting center can collect error information in batches and periodically determine if an error occurs in the operations of the function management and configuration server based on the reported error information. Thus, the error can be treated and removed periodically and human power can be saved substantially.

The above functional modules and units discussed in the embodiments of the disclosure can be implemented, for example, through software in conjunction with general-purpose hardware, or directly via hardware implementations (e.g., via a hardware processor).

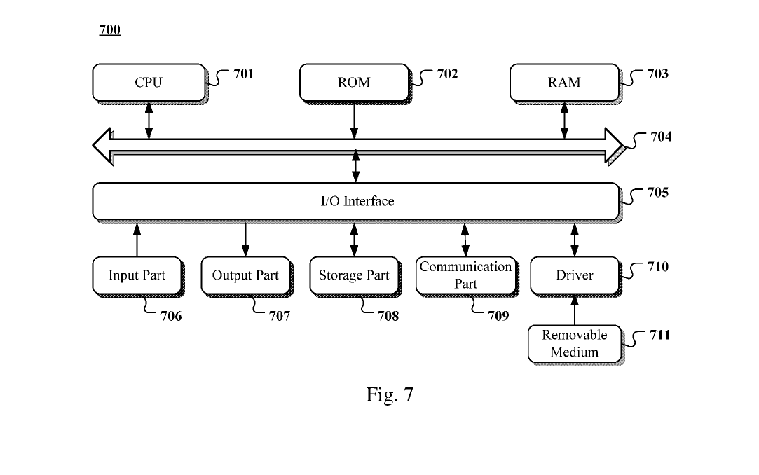

FIG. 7 is a schematic structural view of a computer system of a terminal device or server for realizing the embodiments of the present application. As shown in FIG. 7, computer system 700 includes a (central processing unit) CPU 701, which may execute various actions and processing functions based on the programs stored in a read-on memory (ROM) 702 or the programs loaded from a storing part 708 to a random access memory (RAM) 703. The RAM 703 may also store various data and/or programs required for the operations of the system 700. CPU 701, ROM 702 and RAM 703 may be connected with one another via a bus 704. An input/output (I/O) interface 705 may also be connected to bus 704.

Components connected to I/O interface 705 may include, for example, an input part 706 that includes, for example, a keyboard, a mouse, and the like, an output part 707 that includes, for example a cathode ray tube (CRT), a liquid crystal display (LCD), a speaker, and the like, a storing part 708 that includes, for example a hard disc, and the like, and a communication part 709 that includes, for example, a network interface card such as a local area network (LAN) card, a modem, and the like. Communication part 709 may perform communication processing via a network such as the Internet. A driver 710 may be connected to the I/O interface 705 as needed to ensure proper operation. A detachable medium 711, such as a magnetic disc, an optical disc, an optical-magnetic disc, semiconductor storage, etc., may be mounted to driver 710 such that computer programs read from the detachable medium 711 can be installed in the storing part 708.

Particularly, according to the embodiments of the present application, the steps described in the above reference flow chart can be implemented as a computer program. For example, the embodiments of the present application include a computer program product including a computer program, which is tangibly contained in a machine-readable medium, and the computer program may include a program code for performing the method as shown in the flow chart. In accordance with such embodiments, the computer program can be downloaded and installed from the network via the communication part 709, and/or can be installed from the removable medium 711.

In various embodiments, computer operation instructions may be stored in read-only memory (ROM) 702 or loaded from a storage part 708 to a random access memory (RAM) 703. A processor of a legitimate client may be configured to execute computer operation instructions stored in each memory, so as to execute a method including the steps of:

sending by a legitimate client a function access request to the CDN node;

when the CDN node determines that feedback information of the function access request should be an access refusal result, receiving, by the legitimate client, feedback information of allowed access returned by the CDN node, wherein the feedback information includes characteristic information specific to the legitimate client and corresponding to the access refusal result; and

based on the feedback information, parsing, by the legitimate client, access refusal result of the characteristic information, and reporting, by the legitimate client, error information corresponding to the access refusal result such that the CDN node determines that an error occurs in the operations of the function management and configuration server based on the error information reported by the CDN node.

In an embodiment, a processor of a CDN node for detecting operations of a function management and configuration server may be configured to execute computer operation instructions stored in each memory, so as to execute a method including the steps of:

receiving, by the CDN node, a function access request sent by a legitimate client;

when the CDN node determines that feedback information of the function access request should be an access refusal result, returning by the CDN node feedback information of allowed access to the legitimate client, wherein the feedback information includes characteristic information specific to the legitimate client and corresponding to the access refusal result; and

receiving, by the CDN node, error information corresponding to the access refusal result and reported by the legitimate client, and determining by the CDN node that an error occurs in the operations of the function management and configuration server based on the reported error information.

In various embodiments, the CDN node for detecting operations of a function management and configuration server may implemented as any suitable number and/r type of computing devices. For example, the CDN node may be implemented as a server or server cluster, wherein each unit may be a separate server or server cluster. In such an implementation, interaction among the above units may be interaction among the servers corresponding to the above units.

The foregoing embodiments are illustrative, in which those units described as separate parts may or may not be separated physically. Illustrated components may or may not be physical units, i.e., may be located in one place or distributed in several locations among a network. Some or all modules may be selected according to practical requirement to realize the purpose of the embodiments, and such embodiments can be understood and implemented by the skilled person in the art without undue experimentation.

A person skilled in the art can clearly understand from the above description of embodiments that these embodiments can be implemented through software in conjunction with general-purpose hardware, or directly via hardware implementations. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

Finally, it should be noted that, the above embodiments are provided to describe the technical solutions of the disclosure, but are not intended as a limitation. Although the disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the disclosure.

What is claimed is:

1. A method for detecting operations of a function management and configuration server configuring functions for a content delivery network (CDN) node, the method comprising:
sending, by a legitimate client, a function access request to a CDN node;
receiving, by the legitimate client, a feedback information of allowed access returned from the CDN node when the CDN node determines that feedback information of the function access request should be an access refusal result,
wherein the feedback information includes characteristic information (i) that is specific to the legitimate client, and (ii) that corresponds to the access refusal result;
parsing, by the legitimate client, the access refusal result of the characteristic information based on the feedback information; and
reporting, by the legitimate client, error information corresponding to the access refusal result such that the CDN node determines that an error occurs in the operations of the function management and configuration server based on the error information reported by the CDN node.

2. The method of claim 1, wherein the act of parsing the access refusal result of the characteristic information and reporting the error information comprises:
periodically counting received feedback information and parsing the access refusal result of the characteristic information; and
reporting the error information corresponding to the access refusal result.

3. A method for detecting operations of a function management and configuration server configuring functions for a content delivery network (CDN) node, the method comprising:
receiving, by the CDN node, a function access request sent by the legitimate client;
returning, by the CDN node, feedback information of allowed access to the legitimate client when the CDN node determines that feedback information of the function access request should be an access refusal result,
wherein the feedback information includes characteristic information (i) that is specific to the legitimate client, and (ii) that corresponds to the access refusal result;
receiving, by the CDN node, error information corresponding to the access refusal result and reported by the legitimate client; and
determining, by the CDN node, that an error occurs in the operations of the function management and configuration server based on the reported error information.

4. The method of claim 3, wherein the act of returning feedback information of allowed access to the legitimate client comprises:
determining that the feedback information of the function access request should include a returning code for the access refusal result based on the received function access request;
modifying the returning code for the access refusal result into a returning code for the allowed access mandatorily; and
adding special field information (i) that is specific to the legitimate client, and (ii) that corresponds to the access refusal result, into the feedback information.

5. A content delivery network (CDN) node configured to detect operations of a function management and configuration server configuring functions for the CDN node, the CDN node comprising:
at least one processor; and
a memory in electronic communication with the processor and having instructions stored thereon, wherein execution of the instructions by the at least one processor causes the at least one processor to:
receive a function access request sent by a legitimate client;
return feedback information of allowed access to the legitimate client when it is determined that feedback information of the function access request should be an access refusal result,
wherein the feedback information includes characteristic information (i) that is specific to the legitimate client, and (ii) that corresponds to the access refusal result;
receive error information corresponding to the access refusal result and reported by the legitimate client; and
determine that an error occurs in the operations of the function management and configuration server based on the reported error information.

6. The CDN node of claim 7, wherein execution of the instructions by the at least one processor causes the at least one processor to:
determine that the feedback information of the function access request should include a returning code for the access refusal result based on the received function access request;
mandatorily modify the returning code for the access refusal result into a returning code for the allowed access; and
add special field information (i) that is specific to the legitimate client, and (ii) that corresponds to the access refusal result, into the feedback information.
